(19) United States
(12) Patent Application Publication
(10) Pub. No.: US 2004/0247895 A1
(43) Pub. Date: Dec. 9, 2004

(54) System for releasing active substances and active agents

(76) Inventors: Michael Dreja, Koeln (DE); Wolfgang Von Rybinski, Duesseldorf (DE)

Correspondence Address: HENKEL CORPORATION, THE TRIAD, SUITE 200, 2200 RENAISSANCE BLVD., GULPH MILLS, PA, 19406, US

(21) Appl. No.: 10/725,067

(22) Filed: Dec. 1, 2003

Related U.S. Application Data
(63) Continuation of application No. PCT/EP02/05752, filed on May 24, 2002.

(30) Foreign Application Priority Data
Jun. 1, 2001 (DE) 101 26 966.8

(51) Int. Cl. B32B 9/04; C01B 33/14

(52) U.S. Cl. 428/446; 516/77; 516/79; 516/81

(57) ABSTRACT

A process for making a glass matrix containing an active substance or component by charging a carrier molecule with one or more active substances or components and executing a sol/gel process the presence of the charged carrier molecule to form a gel matrix containing the active substances or components. Films, coverings, layers, and/or coatings composed of porous sol/gel glass matrices based on polysilicic acids, silicates, borates, and/or aluminates, the matrix incorporating carrier molecules charged with one or more active substances and/or components. Porous glass matrices based on silicates, polysilicic acids, borates, and/or aluminates, having incorporated therein carrier molecules charged with at least one active substance and/or component.

This invention relates to a system for releasing active substances or active components, more particularly from surfaces. More particularly, the present invention relates to a composition containing active substances and/or active components, more particularly for the formation of films, layers and/or coatings on surfaces, to a process for its production and to its use.

Many substances which could produce advantageous effects in cosmetic products or detergents are often not sufficiently stable for commercial use or cause troublesome interactions with other product ingredients. For example, active substances or active components, such as perfumes, essential oils, perfume oils and care oils, dyes or pharmaceutical active components, which are used in cosmetic and/or pharmaceutical products or in detergents, often lose their activity during storage or directly during use.

Accordingly, it would be of interest to immobilize and stabilize such substances with the aid of suitable carrier materials. This can be done by inclusion, complexing or adsorption. In many cases, the controlled release of active components over a prolonged period is also of advantage. It is equally often of advantage to remove troublesome ingredients from processes or applications.

For this reason, active substances or active components, such as perfumes, care oils and antibacterial agents, are added to the products in spatially delimited, protected form. Sensitive substances are often encapsulated in capsules of various sizes, adsorbed onto suitable carrier materials or chemically modified. Their release can then be activated by a suitable mechanism, for example mechanically by shearing or by diffusion directly from the matrix material.

Accordingly, there is an ongoing search for systems which are suitable as encapsulation, transport or administration vehicles—often also known as delivery systems or carrier systems.

There are already numerous commercial delivery systems which are based on porous polymer particles or liposomes (for example Microsponges® from Advanced Polymer Systems or Nantopes® from Ciba-Geigy, cf. B. Herzog, K. Sommer, W. Baschong, J. Röding “Nanotopes™: A Surfactant Resistant Carrier System” in SÖFW-Journal, Vol. 124,10/98, pages 614 to 623).

The disadvantage of these conventional systems is that they do not have specific pore sizes so that the adsorption and release kinetics of the encapsulated active components are not controlled. In addition, liposomes are not sufficiently stable for many applications.

In view of the diversity of active substances and active components intended for use in measured amounts in various different fields, there is a constant need to develop other release systems.

Accordingly, the problem addressed by the present invention was to provide a new carrier system for active substances and/or active components which, in particular, would provide for the controlled release of the active substances/components.

Another problem addressed by the present invention was to provide a system with a storage and release function for active substances/components, more particularly on surfaces.

More particularly, the problem addressed by the present invention was also to develop a coating for the storage and/or controlled release of active substances/components such as, for example, dyes and perfumes, care oils, vitamins, enzymes, antibacterial agents or other active components.

It has surprisingly been found that carrier molecules charged with active substances/components in a sol/gel (glass) matrix bind active substances/components and release them under control.

Accordingly, the present invention relates to a process for the production of a composition containing active substances and/or active components which is particularly suitable for the production of films, coverings, layers and/or coatings, a sol/gel process being carried out in the presence of a carrier molecule charged with at least one active substance and/or active component.

Sol/gel processes per se are well-known to the expert (see, for example, Römpp—Lexikon Chemie, 9th Edition, Vol. 5, page 4140, keyword “Sol-Gel-Prozess” and the literature cited there; C. J. Brinker, G. W. Scheerer, “Sol-Gel Science: The physics and chemistry of sol-gel processing”, Academic Press, San Diego, 1998). A sol-gel process is understood to be a process in which glasses or ceramic materials are ultimately obtained from initially soluble compounds via the intermediate stage of a gel.

However, sol-gel processes have not yet been used to produce storage or release systems for active components and active substances. It is applicants' privilege to have found that sol/gel processes are suitable for generating systems of the above-mentioned type.

Accordingly, in the process according to the invention, a sol/gel process is carried out in the presence of a suitable sol/gel precursor and a carrier molecule charged with at least one active substance and/or active component; in other words, a gel is formed from a suitable sol/gel precursor in the presence of a carrier molecule charged with at least one active substance and/or active component. In this way, the carrier molecule charged with at least one active substance and/or active component is incorporated in a preferably porous sol/gel matrix (gel matrix) formed in the sol/gel process.

Accordingly, the sol/gel precursor must lead to the formation of a gel in a sol/gel process, more particularly under hydrolysis conditions (for example acidic hydrolysis, for example with hydrochloric acid), with subsequent polycondensation.

Sol/gel precursors, i.e. starting compounds capable of forming gels, suitable for the purposes of the invention are known per se to the expert. Sol/gel precursors usable in accordance with the invention are, for example, compounds of silicon, boron, aluminium, titanium, zirconium, vanadium, etc. which are capable of forming gels. According to the invention, preferred sol/gel precursors are silicon, boron and/or aluminium compounds, more particularly organosilicon, organoboron and/or organoaluminium compounds.

Sol/gel precursors suitable for the purposes of the invention are selected in particular from the group of di-, tri- and/or tetrafunctional silicic acid, boric acid and alumoesters, more particularly alkoxysilanes (alkyl orthosilicates), and precursors thereof.

One example of sol/gel precursors suitable for the purposes of the invention are alkoxysilanes corresponding to the following general formula:

(R¹O)(R²O)Si(X)(X′)

in which

X is hydrogen or a group —OR³,

X′ is hydrogen or a group —OR⁴ and

R¹, R², R³ and R⁴ independently of one another represent an organic group, more particularly a linear or branched alkyl group, preferably (C₁₋₁₂) alkyl.

According to the invention, particularly preferred compounds are the silicic acid esters tetramethyl orthosilicate (TMOS) and tetraethyl orthosilicate (TEOS).

Other sol/gel precursors suitable for the purposes of the invention are described, for example, in German patent application 100 21 165.9 filed by Henkel KGaA on 29th April, 2000 under the title: “System for the release of active components” of which the disclosure is hereby fully included by reference. These sol/gel precursors are various hydrolyzable organosilanes such as, for example, alkylsilanes, alkoxysilanes, alkyl alkoxysilanes and organoalkoxysilanes. Besides the alkyl and alkoxy groups, other organic groups (for example allyl groups, aminoalkyl groups, hydroxyalkyl groups, etc.) may be attached as substituents to the silicon.

The sol/gel process is carried out with the above-mentioned sol/gel precursors in known manner, i.e. generally by hydrolysis of these compounds, more particularly in the presence of acids, bases or other catalysts, such as fluorides for example, and subsequent polycondensation. According to the invention, acidic hydrolysis is preferred.

The sol/gel process, i.e. gelation (more particularly hydrolysis and subsequent polycondensation), is generally followed by removal of the solvent or dispersant present, if any. This is generally done by heat treatment. The heat treatment, which may optionally be carried out under reduced pressure or vacuum, may be carried out in particular at temperatures of about 20° C. to about 100° C. The heat treatment is carried out in particular for about 1 hour to about 24 hours or longer. The sol/gel process and the heat treatment, for example, may also merge continuously into one another.

The heat treatment not only removes any solvent present, it also converts the preferably porous gel matrix (sol/gel matrix) by further chemical reaction into a preferably porous glass matrix (sol/gel glass matrix) in which the carrier molecules charged with active substance and/or active component are then incorporated. Where silicon, boron and/or aluminium compounds are used as the sol/gel precursor, a matrix based on polysilicic acids, silicates, borates and/or aluminates is formed.

Before the heat treatment, the composition containing active substance and/or active component produced in accordance with the invention by a sol/gel process may be applied as a film, covering, layer and/or coating to the surface of a suitable carrier material, so that coated surfaces are formed after the heat treatment, as described in the following. Layer thicknesses of 100 nm to 10 mm and more particularly 1,000 nm to 2 mm are preferred.

Surface carrier materials suitable for the purposes of the invention, to which the coating composition produced in accordance with the invention may be applied, are for example glasses and ceramics of all kinds; inorganic oxides, such as aluminium oxides, silicon dioxides, magnesium oxides, boron oxides, titanium oxides, etc.; silica gels; cellulose products of all kinds; plastic products of all kinds; woven fabrics, cloths, nonwovens, knitted fabrics and felts of all kinds; metals and metal alloys of all kinds; and other, preferably inert carriers and carrier materials and macroporous and mesoporous carriers. Other suitable carriers are spherical carrier particles of the above-mentioned materials.

In one embodiment, therefore, the present invention relates to a process for the production of a composition containing active substances and/or active components, more particularly for the formation of films, layers and/or coatings, characterized in that it comprises the following steps:

(a) charging a suitable carrier molecule with at least one active substances and/or active component;

(b) preparing a homogeneous mixture of the carrier molecule charged in step (a) with a suitable sol/gel precursor, optionally in the presence of a suitable solvent or dispersant;

(c) carrying out a sol/gel process in the mixture prepared in step (b) to form a preferably porous sol/gel matrix in which the carrier molecules charged with active substance and/or active component are incorporated;

(d) optionally heat-treating the sol/gel matrix formed in step (c) to remove any solvent or dispersant present and to form a preferably porous sol/gel glass matrix, preferably based on polysilicic acids, silicates, borates and/or aluminates, in which the carrier molecules charged with active substance and/or active component are incorporated.

The mixture prepared in step (b) and/or the sol/gel matrix produced in step (c) may be processed to, or applied as, a film, covering, layer and/or coating. For example, the mixture prepared in step (b) and/or the sol/gel matrix produced in step (c) may be applied to a preferably inert carrier surface, preferably as a film, covering, layer and/or coating; examples of carrier surfaces suitable for the purposes of the invention can be found in the foregoing text. Layer thicknesses of 100 nm to 10 mm and more particularly 1,000 nm to 2 mm are preferred. As described above, the carrier surface coated with the preferably porous sol/gel glass matrix containing the carrier molecules charged with active substances and/or active components in incorporated form may be subjected to a heat treatment to remove any solvent or dispersant present and to form a carrier surface coated with a preferably porous sol/gel glass matrix, preferably based on silicates, polysilicic acids, borates and/or aluminates, the sol/gel glass matrix containing the carrier molecules charged with active substances and/or active components in incorporated form, preferably in homogeneous distribution; in other words, the heat treatment converts the gel matrix initially produced by a sol/gel process (also synonymously referred to herein as “sol/gel matrix”) into a glass matrix (also synonymously referred to herein as “sol/gel glass matrix”).

As described above, the sol/gel process is carried out in the presence of a carrier molecule charged with at least one active substance and/or active component. The carrier molecule is a molecule or a compound with molecular cavities, voids, pores, channels, pockets or the like which are capable of accommodating the particular active substance and/or active component molecules. In other words, the carrier molecule or the carrier compound must have sufficiently large molecular cavities, voids, pores, channels, pockets or the like to accommodate the particular active substance and/or active component molecules by inclusion, incorporation, complexing or the like. Cavities with diameters of about 200 to about 1,500 pm, more particularly of about 300 to about 1,400 pm and preferably of about 400 to about 1350 pm are generally required for this purpose.

In addition, it can be of advantage for certain applications if the molecular cavities, voids, pores, channels, pockets or the like of the carrier molecules contain polar groups, for example are hydrophilic or hydrophobic, depending on the nature of the active substance and/or active component molecule to be incorporated. The carrier molecule is preferably an organic carrier molecule.

Examples of carrier molecules suitable for the purposes of the invention are any molecules, more particularly organic molecules, with molecular cavities, voids, pores, channels, pockets or the like which are large enough to accommodate, i.e. incorporate, include, complex, etc., the particular active substance and/or active component molecules, i.e. for example compounds which form clathrates or cage compounds with the active substance and/or active component molecules to be incorporated or compounds which form complexes, for example chelate complexes, with the active substance or active component molecules to be incorporated, etc. and which are compatible with the sol/gel (glass) matrix, i.e. can be incorporated in molecularly disperse form or molecularly organized form.

In one particular embodiment, the carrier molecule may be selected from the group of cyclodextrins (cycloamyloses, cyloglucans) and calixarenes, optionally in modified and/or activated form, and derivatives and mixtures thereof. Where cyclodextrins are used as the carrier molecules in accordance with the invention, they may be selected from the group of α-, β- and γ-cyclodextrins, optionally in modified or activated form, and derivatives thereof. Examples of functionalized or modified cyclodextrins include alkyl- and/or hydroxyalkyl- and/or amino-substituted cyclodextrins.

The properties of cyclodextrins suitable as the carrier molecule in accordance with the invention are set out in the following Table:

| | α-Cyclodextrin | β-Cyclodextrin | γ-Cyclodextrin |
|---|---|---|---|
| Glucose units | 6 | 7 | 8 |
| Molecular weight | 973 | 1,135 | 1,297 |
| Cavity diameter (Å) | 4.7-5.3 | 6-6.6 | 7.5-8.3 |
| Internal diameter (Å) | 5.7 | 7.8 | 9.5 |
| External diameter (Å) | 13.7 | 15.3 | 16.9 |
| Cavity height (Å) | 7.9 | 7.9 | 7.9 |
| Cavity volume | 174 | 262 | 472 |
| (ml/mol) | | | |

The charging of the carrier molecules with active substances and/or active components is known per se to the expert and, according to the invention, may be carried out by any of the methods known from the prior art.

The concentration ratio of active substance or active component to carrier molecule (for example cyclodextrins) may be varied within wide limits and, for example, may reach 1:1 (molar), i.e. may amount to one active substance or active component molecule per carrier molecule.

The concentration of the carrier molecule (for example cyclodextrin/active component complex) charged with active substance and/or active component in the starting solution or dispersion for the sol/gel process may also vary within wide limits and may amount, for example, to 0.1 to 99% by weight and, more particularly, to 5 to 25% by weight, based on the starting solution or dispersion.

The concentration of sol/gel precursor in the starting solution or dispersion (for example silicate precursor, such as TMOS or TEOS) may also vary within wide limits and may amount, for example, to 20 to 80% by weight and more particularly to 30 to 60% by weight.

The sol/gel process per se may be carried out in broad temperature ranges, more particularly at 0 to 100° C., preferably at 20 to 80° C. and more particularly at 40 to 60° C. The reaction time may be about 1 hour to about 2 days and is preferably 2 hours. The reaction is preferably carried out at low or acidic pH values, more particularly at pH values below 7, more particularly in the range from 0 to 3 and preferably in the range from 1.7 to 2.

A typical preparation of organic/inorganic hybrid layers according to the invention by a sol/gel process is carried out at follows:

Suitable coating solutions or dispersions are prepared by mixing a suitable sol/gel precursor such as, for example, a tetraalkoxysilane or tetraalkyl orthosilicate with the formula Si(OR)₄, such as TMOS or TEOS, with a suitable hydrolysis medium (for example hydrochloric acid HCl) and with the active substance and/or active component complexed with or incorporated in an organic carrier molecule. Substances with molecular cavities, for example cyclodextrins or calixarenes, may be used as the complex carrier molecules. The complexing molecule suitable for each active component has to be selected on the basis of the size of the molecular cavity. The coating solution is then applied, for example, to a solid carrier, for example a glass plate. After heat treatment, for example for 24 hours at ca. 60° C., optionally in vacuo, a solid film containing the active component is formed.

In principle, the incorporation of molecular complexes of carrier molecules, for example cyclodextrins, and active substance and/or active component molecules adapted thereto is sufficient to achieve a controlled release of the active components from the coatings. The release process is then determined solely by the complexing constant for the active oxygen and/or active component in the carrier molecule (for example cyclodextrin or calixarene) and the rate of diffusion of the active component through the coating material (for example silicate). Accordingly, the release process presupposes either porosity of the material and/or a certain solubility of the active component in the material to allow access to the surface of the coating and hence to enable release to take place. These conditions are generally satisfied. However, an additional control is created by certain carrier molecules, such as cyclodextrins for example, undergoing self-organization of their arrangement in the coating material by virtue of their amphiphilic character. Thus, both the uncharged cyclodextrins and the cyclodextrins charged with active substances and/or active components organize themselves into worm-like or isolated spherical pores, particularly at certain concentrations. In the case of the worm-like pores, the active components can be released by gradual delivery from the channel structure which, again, is dependent on the complexing constant of the active component. In the case of the spherical pores, the active components are released in batches from the coating.

The active substances and/or active components with which the carrier molecules are charged may be any active substances and/or active components. Particularly preferred active substances and/or active components are substantially inert under the reaction conditions of the sol/gel process or are substantially unreacted. In addition, it can be of advantage for certain applications if the active substance or active component is at least partly soluble in the gel and/or glass matrix.

For example, the active substance and/or active component may be selected from the group of perfumes; oils, such as essential oils, perfume oils, care oils, fragrance oils and silicone oils; antibacterial, antiviral or fungicidal agents; disinfecting and antimicrobial substances; deodorants; antioxidants; pharmaceutically active substances; biologically active substances and biogenic agents; vitamins and vitamin complexes; enzymes and enzymatic systems, such as amylases, cellulases, lipases and proteases; cosmetically active substances, such as ingredients for cosmetics and body care products; detersive substances, such as surfactants of all kinds, detersive inorganic and organic acids, soil repellents and soil release agents, oxidizing agents and bleaching agents, such as in particular hypochlorites and peroxides, bleach activators, builders and co-builders, anti-redeposition additives, discoloration inhibitors, color protectors, laundry care substances and additives, optical brighteners, foam inhibitors, pH adjusters and pH buffers; UV protection factors, UV absorbers, fluorescing and phosphorescing agents; dyes, dye compositions, pigments and other coloring substances, such as solvatochromic and indicator dyes; and mixtures of the above-mentioned compounds.

The process according to the invention leads to the production of compositions containing active substances and/or active components which are particularly suitable for the formation of films, coverings, layers and/or coatings on carrier surfaces of all kinds. Accordingly, the process according to the invention is equally a process for the production of carrier surfaces with a protective function and/or storage function for active substances and/or active components and, hence, is also a process for the protection and/or storage of active substances and/or active components, more particularly on carrier surfaces. The carrier surfaces thus coated have a controlled release function for active substances and/or active components.

The present invention also relates to the compositions containing active substances and/or active components, more particularly for the formation of films, coverings, layers and/or coatings, obtainable by the process according to the invention and to the films, coverings, layers and/or coatings formed from the compositions. The films, coverings, layers and/or coatings are, in particular, films, coverings, layers and/or coatings which have a preferably porous sol/gel glass matrix, more particularly based on polysilicic acids, silicates, borates and/or aluminates, for the incorporation—preferably in uniform distribution throughout the matrix—of carrier molecules with active substance and/or active component molecules incorporated and/or complexed in their molecular cavities, voids, pores, channels or the like. As mentioned above, thicknesses for the films, coverings, layers, coatings or the like of 100 nm to 10 mm and, more particularly, 1,000 nm to 2 mm are preferred for the purposes of the invention.

The present invention also relates to surfaces, more particularly surfaces of inert carrier materials, to which films, coverings, layers, coatings or the like of the above-mentioned type are applied. As described above, the surfaces in question are in particular surfaces with a protective and/or storage function for active substances and/or active components or with a controlled release function for active substances and/or active components.

The process according to the invention affords a number of advantages of which the following are mentioned as just a few examples:

The process according to the invention enables coatings with a storage function for the controlled release of active substances or active components to be produced. Where cyclodextrins, for example, are used, they form spontaneously self-organized aggregates in the surface coating, more particularly silicate coating, which control the release properties. By using various, optionally modified carrier molecules (for example various cyclodextrins), the release kinetics can be controlled through the size and geometry of the self-organized aggregation structures. A range of effects can be achieved according to the active substances or active components incorporated or included, including for example special perfume effects, antibacterial effects, cleaning effects, etc. Another advantage of the present invention is the fact that the coatings, layers, coverings, films and the like can be directly formed from solution. In the case of organic carrier molecules charged with active substances/components and inorganic sol/gel glass matrixes, inorganic-organic hybrid storage systems are formed which are particularly suitable for the controlled release of active substances or active components from surfaces, more particularly in the form of coatings, layers, coverings, films, etc., so that they may be used for numerous applications. Other advantages of the present invention will become clear to the expert on reading the specification.

The following Examples are intended to illustrate the invention without limiting it in any way.

Other embodiments, modifications and variations of the present invention will become clear to the expert on reading the specification and practicable without having to depart from the scope of the present invention.

### EXAMPLES

### Example 1

Coatings were formed on glass carriers by casting a solution of the formulations shown below. The coatings were placed in a drying cabinet and left to react for 24 hours at 60° C. Solid coatings were obtained from which the active substance was released with considerable delay.

a) Preparation of Coatings With a Perfume Effect

10 g water and 27.5 g TEOS were added to a solution of 10 g hydroxypropyl-substituted p-cyclodextrin charged with orange oil. The pH was then adjusted to a value of 1.7 with HCl.

After heat treatment under the conditions described above, a coating with a worm-like pore structure was obtained and had a long-lasting perfume effect.

b) Preparation of Coatings With an Antibacterial Effect

10 g water and 27.5 g TEOS were added to a solution of 10 g methyl-substituted p-cyclodextrin charged with phenol. The pH was then adjusted to a value of 1.7 with HCl.

After heat treatment under the conditions described above, a coating with a worm-like pore structure was obtained and had a long-lasting antibacterial effect.

1-27. (canceled)

28. A process for the production of a composition containing an active substance or component, comprising the steps of charging a carrier molecule with one or more active substances or components and executing a sol/gel process the presence of the charged carrier molecule to form a gel matrix comprising the active substances or components.

29. The process of claim 28, wherein the gel matrix is in the form of a film, covering, layer, or coating.

30. The process of claim 28, wherein a sol/gel precursor is employed in the sol/gel process.

31. The process of claim 28, wherein a porous sol/gel matrix is formed in the sol/gel process.

32. The process of claim 28, wherein the sol/gel process is followed by a heat treatment for about 1 hour to about 24 hours, optionally under reduced pressure, at temperatures of about 20° C. to about 100° C.

33. The process of claim 32, wherein the heat treatment removes solvent or dispersant present and results in a porous sol/gel glass matrix.

34. The process of claim 33, wherein the glass matrix is based on one or more polysilicic acids, silicates, borates and/or aluminates.

35. The process of claim 28, wherein the carrier molecule has molecular cavities, voids, pores, or channels to accommodate the active substances or components.

36. The process of claim 28, wherein the carrier molecule is an organic molecule.

37. The process of claim 28, wherein the carrier molecule is selected from the group consisting of cyclodextrins, calixarenes, modified and/or activated forms thereof, and derivatives and mixtures thereof.

38. The process of claim 37, wherein the cyclodextrins are selected from the group consisting of α-, β- and γ-cyclodextrins, modified and/or activated forms thereof, and derivatives and mixtures thereof.

39. The process of claim 28, wherein the sol/gel process employs a sol/gel precursor comprising one or more gel-forming compounds of silicon, boron, aluminium, titanium, zirconium and/or vanadium.

40. The process of claim 39, wherein the sol/gel precursor comprises one or more gel-forming compounds of silicon, boron, and/or aluminium.

41. The process of claim 39, wherein the sol/gel precursor comprises one or more gel-forming organic silicon, boron and/or aluminium compounds.

42. The process of claim 41, wherein the organic silicon, boron, and/or aluminium compounds are selected from the group consisting of di-, tri- and/or tetrafunctional silicic acid, boric acid and alumoesters.

43. The process of claim 42, wherein the one or more gel-forming organic compounds comprise one or more alkoxysilanes and/or alkyl orthosilicates.

44. The process of claim 43, wherein the alkoxysilanes comprise one or more compounds of the formula:
(R¹O)(R²O)Si(X)(X′)
in which
X is hydrogen or a group —OR
X′ is hydrogen or a group —OR⁴ and
R¹, R², R³ and R⁴ independently represent organic groups.

45. The process of claim 44, wherein R¹, R², R³ and R⁴ independently represent linear or branched alkyl groups.

46. The process of claim 45, wherein R¹, R², R³ and R⁴ independently represent (C₁₋₁₂) alkyl groups.

47. The process of claim 42, wherein the silicic acid ester comprises tetramethyl orthosilicate (TMOS) or tetraethyl orthosilicate (TEOS).

48. The process of claim 28, wherein the active substances or components are selected from the group consisting of perfumes, oils, essential oils, perfume oils, care oils, fragrance oils and silicone oils, antibacterial, antiviral, and fungicidal agents, disinfecting and antimicrobial substances, deodorants, antioxidants, pharmaceutically active substances, biologically active substances, biogenic agents, vitamins, vitamin complexes, enzymes, enzymatic systems, cosmetically active substances, detersive substances, inorganic and organic acids, soil repellents, soil release agents, oxidizing agents, bleaching agents, bleach activators, builders, co-builders, anti-redeposition additives, discoloration inhibitors, color protectors, laundry care substances and additives, optical brighteners, foam inhibitors, pH adjusters, pH buffers, UV protection factors, UV absorbers, fluorescing, and phosphorescing agents, dyes, dye compositions, pigments and other coloring substances, and mixtures thereof.

49. A process for the production of a composition containing active substances and/or active components, comprising the following steps:
(a) charging a suitable carrier molecule with at least one active substance and/or active component;
(b) preparing a homogeneous mixture of the carrier molecule charged in step (a) with a suitable sol/gel precursor, optionally in the presence of a suitable solvent or dispersant;
(c) carrying out a sol/gel process in the mixture prepared in step (b) to form a sol/gel matrix in which the carrier molecules charged with active substance and/or active component are incorporated;
(d) optionally heat-treating the sol/gel matrix formed in step (c) to remove any solvent or dispersant present.

50. The process of claim 49, wherein the mixture prepared in step (b) and/or the sol/gel matrix produced in step (c) is processed to, or applied as, a film, covering, layer, and/or coating.

51. The process of claim 49, wherein the mixture prepared in step (b) and/or the sol/gel matrix produced in step (c) is applied to an inert carrier surface.

52. The process of claim 51, wherein the carrier surface coated with the sol/gel matrix containing the carrier molecules charged with active substances and/or components in incorporated form is subjected to a heat treatment to remove solvent or dispersant present, and to form a carrier surface coated with a sol/gel matrix comprising the carrier molecules charged with active substances and/or components in incorporated form.

53. The process of claim 52, wherein the sol/gel matrix is porous.

54. The process of claim 52, wherein the sol/gel matrix is based on silicates, polysilicic acids, borates and/or aluminates.

55. The process of claim 52, wherein the active substances and/or components are in uniform distribution throughout the matrix that coats the carrier surface.

56. A film, covering, layer, and/or coating that comprises a porous sol/gel glass matrix based on one or more polysilicic acids, silicates, borates, and/or aluminates, the matrix having incorporated therein carrier molecules charged with one or more active substances and/or components.

57. An inert carrier surface to which a film, covering, layer, and/or coating according to claim 56 has been applied.

58. The surface of claim 57, having a protective and/or storage function for the active substances and/or components.

59. The surface of claim 57, having a controlled release function for the active substances and/or components.

60. A glass matrix based on one or more silicates, polysilicic acids, borates, and/or aluminates, the glass matrix being porous and having incorporated therein in uniform distribution carrier molecules charged with at least one active substance and/or component.
